(19) United States
(12) Patent Application Publication
(10) Pub. No.: US 2024/0416174 A1
(43) Pub. Date: Dec. 19, 2024

(54) REHABILITATION EXERCISE APPARATUS FOR SPINE AND KNEES

(71) Applicant: Wang Geun AN, Seoul (KR)

(72) Inventor: Wang Geun AN, Seoul (KR)

(21) Appl. No.: 18/695,026

(22) PCT Filed: Sep. 26, 2022
(86) PCT No.: PCT/KR2022/014380

§ 371 Date: Mar. 25, 2024

(30) Foreign Application Priority Data
Sep. 27, 2021 (KR) 10-2021-0127041

(51) Int. Cl. A63B 23/04; A63B 21/06

(52) U.S. Cl. CPC A63B 23/047; A63B 21/0618

(57) ABSTRACT

Disclosed herein is a rehabilitation exercise apparatus for the spine and knees. The rehabilitation exercise apparatus includes: a body member (110) configured such that moving wheels (115) are installed at bottoms of a pair of vertical frames (111, and 112) spaced apart from each other by a predetermined distance; a load-support member (130) coupled to the pair of vertical frames (111 and 112) in a height-adjustable manner, and coupled to the vertical frames (111 and 112); and a weight member (150) installed on one side of the lower portion of the body member (110) so that weights corresponding to the weight of the user's upper body can be transmitted to the load support member (130) as the load support member (130) is rotated by a predetermined angle. Accordingly, a user can take rehabilitation exercise while walking with the armpits, arms, or shoulders supported on the load support member (130).

### TECHNICAL FIELD

The present invention relates to a rehabilitation exercise apparatus for the spine and knees, and more particularly to a rehabilitation exercise apparatus for the spine and knees that enables walking and rehabilitation exercise to be performed in the state in which the load applied onto a user's spine and knees is reduced by lifting the user's upper body using the load of weights.

### BACKGROUND ART

Humans who walk upright always have a heavy load on their spine due to gravity.

The spine is deformed and degenerated due to occupational work, accidents, aging, and congenital diseases, thereby causing many people to suffer from scoliosis, a herniated disk (a slipped disk), spinal stenosis, etc.

In particular, modern people are becoming more serious as they lack exercise and spend more time sitting.

Furthermore, adolescent students are at high risk of developing spinal deformities such as scoliosis due to congenital spinal deformity, poor posture such as long-term study posture and long-term computer use, etc.

When such a spinal deformity is not corrected in its early stage, it can develop into a chronic disease, so that caution and observation are required.

Scoliosis refers to the sideways curve of the spine from its central axis when viewed from the front. In reality, scoliosis is not a simple two-dimensional (3D) deformation, but a 3D deformation that is accompanied by the rotational deformation of the vertebral body and causes the normal curvature to disappear even when viewed from the side.

Furthermore, it is known that scoliosis causes the abnormal curvature of the spine, which results in tension in the muscles and ligaments around the spine, and also results in symptoms including visual and functional defects and emotional disorders, such as headaches, pain in the neck, shoulders and lower back, frequent fatigue, and chronic fatigue, through pressure on the nerves.

Domestic and international treatment and research trends for scoliosis so far have mostly been non-surgical treatments including manual corrective exercise treatment by professional therapists and bracing treatment, and orthodontic treatment using surgical therapy.

Bracing treatment, which is a non-surgical treatment, not only takes a long treatment period, but the treatment effect of bracing treatment is also minimal compared to the cost, and patients' satisfaction with the bracing treatment was low due to discomfort in fit and appearance.

Furthermore, manual correction treatment is less effective because it is applied when the spinal segment is not fixed, and most of the medical equipment used in this treatment is expensive imported medical equipment and thus high expenses are paid for this treatment.

Surgical therapy can only be performed when there is an angular deformation that allows surgery to be applied, and the medical costs are high and a long rehabilitation period is required, so that there is a problem of low efficiency.

Therefore, there is an urgent need to develop a new fusion rehabilitation exercise apparatus that can maximize the treatment effect for scoliosis correction while lowering medical costs.

Meanwhile, a herniated disk (a slipped disk) is a disease in which the space between the lumbar vertebrae is compressed and narrowed or fluid escapes due to the deformation of the annulus fibrosus, so that pressure is applied onto the nerves, causing pain.

The best way to treat this disk is to widen the narrowed space between the lumbar vertebrae and create a negative pressure state between the spinal cords, thereby reducing the pressure on the nerves and thus reducing pain.

Accordingly, when a herniated disc occurs, a treatment method that widens the space between the lumbar vertebrae and strengthens the surrounding muscles using a decompression traction therapy device is commonly applied.

However, such decompression traction therapy devices are considerably expensive products and require excessive treatment costs, and existing physical therapy devices are less efficient due to insufficient therapeutic effects and a long treatment period.

For example, Patent Document 1 (Korean Patent No. 10-1272196) discloses a ‘Rehabilitation Exercise Equipment for Spine Correction.’

The rehabilitation exercise apparatus for spine correction according to Patent Document 1 is a rehabilitation exercise apparatus for spine correction, including a bed element configured to be supported by a frame and provide a place for a user to lie down on, binding elements configured to secure a user's pelvis and head, respectively, and an exercise element provided such that the user can take exercise using his or her feet and arms, wherein a seat configured such that the user can sit thereon is provided on one side of the frame, wherein a seesaw bed is arranged in succession behind this seat and is supported to be rotated such that it can be tilted backward from an upright state, wherein the frame comes into contact with and is supported on the ground, and includes a support frame arranged horizontally by connecting a plurality of pipes, a first vertical frame provided vertically on one side of the front of the support frame and installed with a foot exercise device on the upper portion thereof, a second vertical frame provided vertically on one side of the rear of the first vertical frame and provided with a sheet on the upper portion thereof, and a third vertical frame provided vertically on one side of the rear of the second vertical frame and rotatably installed with the bed on the upper portion thereof.

The first vertical frame includes: a lower bar configured such that the lower end thereof is hinged to one side of the support frame so as to be rotatable in the front and rear directions; and an upper bar located on the upper portion of the lower bar and hinged so as to be rotatable in the forward and backward directions.

Patent Document 2 (Korean Utility Model Registration No. 20-0463327) ‘Spine Correction Exercise Apparatus.’

The spine correction exercise apparatus according to Patent Document 2 includes: a base frame body including a support frame provided at the lower part, a central support frame vertically connected from the rear top of the support frame and provided with a bent portion extending from the top, a reinforcement frame configured such that the lower end thereof is connected to the support frame and the other end thereof is connected to the central support frame, and an auxiliary frame horizontally disposed inside the support frame; a support plate welded to a bent portion extending from the top of the central support frame, and a rotation guide provided on the front surface of the support plate; a rotation body configured such that a rotation shaft is connected to the rotation guide and located at the center of the upper end thereof and the lower end of the rotation shaft is welded and fixed to the upper end thereof, and grippers are provided on both sides; two backrest frames configured such that first ends thereof are welded to both sides of the rear of the rotation body and backrests provided at the remaining ends of the backrest frames, respectively; a head support frame configured such that one end thereof is welded to the upper portion of the central support frame, and a head support configured to be welded and fixed to the remaining end of the head support frame, and formed in an arc shape; and a chair provided inside the support frame of the base frame.

### DISCLOSURE

### Technical Problem

The present invention is intended to overcome the problems described above, and an object of the present invention is to provide a rehabilitation exercise apparatus for the spine and knees that enables a user to take rehabilitation exercise while walking in the state in which the load on the user's spine and knees is reduced due to the load of weights.

Another object of the present invention is to provide a rehabilitation exercise apparatus for the spine and knees that reduces the load on the spine by weights corresponding to a user's body weight, thereby alleviating the pain caused by nerve compression, narrowing and deformation and also allowing the user to take exercise while walking.

Still another object of the present invention is to provide a rehabilitation exercise apparatus for the spine and knees that enables a user to take rehabilitation exercise while protecting the spine and knees more stably by using a waist protector and a traction wire.

### Technical Solution

In order to accomplish the above objects, the present invention provides a rehabilitation exercise apparatus for the spine and knees, the rehabilitation exercise apparatus including: a body member (110) configured such that moving wheels (115) are installed at bottoms of a pair of vertical frames (111, and 112) spaced apart from each other by a predetermined distance; a load-support member (130) coupled to the pair of vertical frames (111 and 112) in a height-adjustable manner, and coupled to the vertical frames (111 and 112) to support a user's upper body; and a weight member (150) installed on one side of the lower portion of the body member (110) so that weights corresponding to a weight of the user's upper body can be transmitted to the load support member (130) as the load support member (130) is rotated by a predetermined angle.

The rehabilitation exercise apparatus may further include: a waist protector member (170) worn on the user's waist and shoulders; and a wire traction member (190) installed on the body member (110) to lift the weight member (150) more safely.

The body member (110) may include: the first vertical frame (111) formed vertically, and configured such that a plurality of height adjustment holes (111a) are formed at regular height intervals to enable coupling of the load support member (130) to an upper portion thereof; the second vertical frame (112) formed vertically, and configured such that a plurality of height adjustment holes (112a) are formed at regular height intervals to enable coupling of the load support member (130) to an upper portion thereof; lower horizontal frames (113) fixed to front surfaces of the vertical frames (111 and 112); moving wheels (115) rotatably coupled to the lower horizontal frames (113); and auxiliary wheel units (116) installed to be movable along a ground together with the moving wheels (115) as the body member (110) is pulled by a predetermined angle.

The load support member (130) may include: a pair of height adjustment frames (131) coupled to the vertical frames (111 and 112), and provided with a plurality of height adjustment holes (132) that are formed at regular intervals corresponding to the height adjustment holes (111a and 112a) of the vertical frames (111 and 112); a pair of lower support frames (133) extending to first sides of the height adjustment frames (131), and fixed in a horizontal direction to the height adjustment frames (131) to support the user's arms; vertical frames (134) fixed in the vertical direction to first ends of the lower support frames (133); a pair of shoulder support frames (135) fixed to top ends of the vertical frames (134) to support the user's shoulders so that they are located above the lower support frames (133); and a front grip frame (136) formed between the pair of shoulder support frames (135) in an integrated form so that the user can pull the body member (110) and the weight member (150).

The weight member (150) may include: a base body (151) formed in a predetermined size; angle adjustment frames (152) formed to be inclined at a predetermined angle on one side of the base body (151) so that the base body (151) can be rotated; angle adjustment holes (154) formed in the angle adjustment frames (152); a buffer plate (155) installed on a top surface of the base body (151); a plurality of weights (157) installed on a top surface of the buffer plate (155) so that a predetermined amount of weight can be applied to the load support member (130); a rotation frame (158) fixed to the vertical frames (111 and 112) of the body member (110); a rotation axis (159) coupled to the rotation frame (158) so that the angle of the angle adjustment frame (152) can be adjusted; and auxiliary wheel units (160) installed on a bottom surface of the base body (151).

The wire traction member (190) may include: a central vertical frame (191) formed in an inverted and reversed ‘L’ shape; a lower horizontal frame (192) fixed to a lower portion of the central vertical frame (191) so that the central vertical frame (191) can be fixed to the body member (110); an upper fixing frame (193) fixed to an upper side of the lower horizontal frame (192) so that the central vertical frame (191) can be fixed to the body member (110); a pair of vertical frames (194) fixed to an upper portion of the central vertical frame (191) and the upper fixing frame (193); and a wire (195) movably installed inside the central vertical frame (191).

### Advantageous Effects

In accordance with the rehabilitation exercise apparatus for the spine and knees according to the present invention, the load applied onto the spine and knees is reduced and also the weight transmitted to the spine and knees due to standing upright is reduced in the state in which the armpits, arms, or shoulders are placed on the load support member, so that pain can be reduced and a user can perform strength exercise and rehabilitation exercise while walking in a stable posture.

In accordance with the rehabilitation exercise apparatus for the spine and knees according to the present invention, the weight member is appropriately adjusted according to a user's physical condition, so that pressure or load attributable to body weight can be reduced and the user can take rehabilitation exercise while walking in the state of being appropriately lifted from the ground.

Furthermore, an effect is obtained in that rehabilitation treatment can be performed in a more comfortable condition along with a rehabilitation therapist in the state in which a user's weight is reduced by the waist protector and the wire traction member.

Furthermore, severely ill patients who have difficulty in walking can also take rehabilitation exercise more stably along with their guardians while relying on the rehabilitation exercise apparatus.

### DESCRIPTION OF DRAWINGS

FIG. 1 is an exploded 3D view showing a rehabilitation exercise apparatus for the spine and knees according to a first preferred embodiment of the present invention;

FIG. 2 is an exploded 3D view showing the rehabilitation exercise apparatus for the spine and knee according to the first preferred embodiment of the present invention;

FIG. 3 is an exploded 3D view showing the rehabilitation exercise apparatus for the spine and knees according to the first preferred embodiment of the present invention;

FIG. 4 is a 3D diagram showing the rehabilitation exercise apparatus for the spine and knees according to the first preferred embodiment of the present invention;

FIG. 5 is a 3D diagram showing the rehabilitation exercise apparatus for the spine and knees according to the first preferred embodiment of the present invention;

FIG. 6 is a front view showing the rehabilitation exercise apparatus for the spine and knees according to the first preferred embodiment of the present invention;

FIG. 7 is a front view showing a state in which the rehabilitation exercise apparatus for the spine and knees according to the first preferred embodiment of the present invention is tilted;

FIG. 8 is a front view showing a state in which a rehabilitation exercise apparatus for the spine and knees according to a preferred second embodiment of the present invention is tilted;

FIG. 9 is a 3D view showing the wire traction member of a rehabilitation exercise apparatus for the spine and knee according to a third preferred embodiment of the present invention;

FIG. 10 is a front view showing the wire traction state of the rehabilitation exercise apparatus for the spine and knees according to the third preferred embodiment of the present invention; and

FIG. 11 is a side view showing the rehabilitation exercise apparatus for the spine and knees according to the third preferred embodiment of the present invention.

### BEST MODE

The present invention provides a rehabilitation exercise apparatus for the spine and knees, the rehabilitation exercise apparatus including: a body member (110) configured such that moving wheels (115) are installed at bottoms of a pair of vertical frames (111, and 112) spaced apart from each other by a predetermined distance; a load-support member (130) coupled to the pair of vertical frames (111 and 112) in a height-adjustable manner, and coupled to the vertical frames (111 and 112) to support a user's upper body; and a weight member (150) installed on one side of the lower portion of the body member (110) so that weights corresponding to a weight of the user's upper body can be transmitted to the load support member (130) as the load support member (130) is rotated by a predetermined angle.

### MODE FOR INVENTION

Embodiments of the present invention will be described in detail below with reference to the accompanying drawings so that those having ordinary skill in the art can easily practice the present invention.

However, the description of the present invention is only embodiments for the structural and functional description thereof, so that the scope of rights of the present invention should not be construed as limited by the embodiments described in the text.

For example, the embodiments may be subject to various modifications and have various forms, so that the scope of rights of the present invention should be understood to include equivalents that can realize the technical spirit.

Furthermore, objects or effects presented in the present invention do not mean that a specific embodiment must include all or only such effects, so that the scope of rights of the present invention should not be understood as being limited thereby.

In the present specification, the embodiments are provided to make the disclosure of the present invention complete and to fully inform those having ordinary skill in the art of the scope of the invention. Furthermore, the present invention is only defined by the scope of the claims.

Accordingly, in some embodiments, well-known components, well-known operations and well-known techniques are not specifically described in order to avoid the ambiguous interpretation of the present invention.

Meanwhile, the meanings of the terms described in the present invention are not limited to the dictionary meanings, and should be understood as follows.

All terms used herein have the same meanings as commonly understood by those having ordinary skill in the art to which the present invention pertains, unless otherwise defined.

The terms defined in commonly used dictionaries should be interpreted as consistent with the meanings they have in the context of the relevant technology. Unless clearly defined in the present invention, they cannot be interpreted as having ideal or excessively formal meanings.

A rehabilitation exercise apparatus for the spine and knees according to a preferred embodiment of the present invention will be described in detail below with reference to the accompanying drawings.

The rehabilitation exercise apparatus for the spine and knees according to the preferred embodiment of the present invention includes: a body member 110 configured such that moving wheels 115 are installed at the bottom portion of a pair of vertical frames 111 and 112 spaced apart from each other by a predetermined distance; a load support member 130 coupled to the pair of vertical frames 111 and 112 in a height-adjustable manner and coupled to the vertical frames 111 and 112 to support the user's upper body; and a weight member 150 installed on one side of the bottom portion of the body member 110 so that, as the load support member 130 is rotated by a predetermined angle, the weight corresponding to the user's upper body load is transmitted to the load support member 130.

### First Embodiment

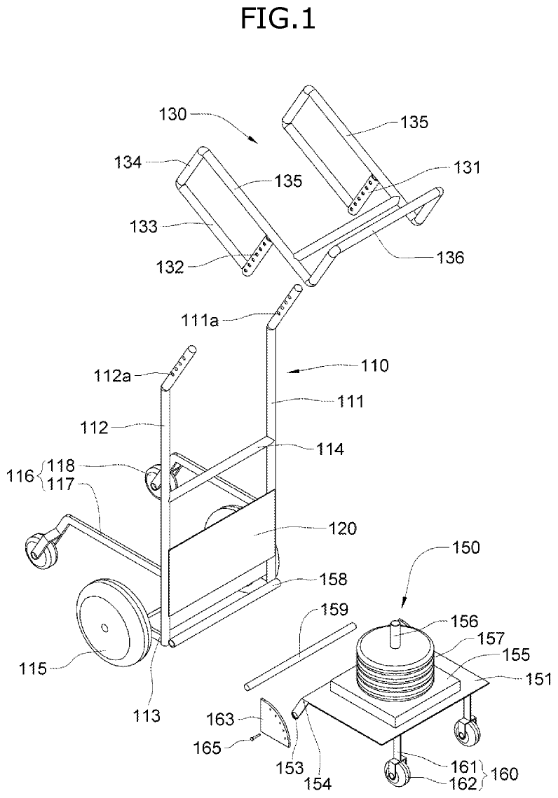

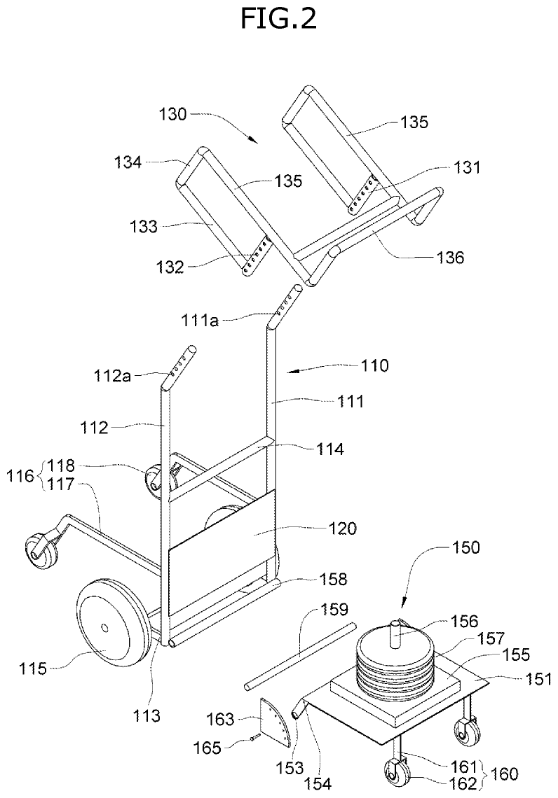

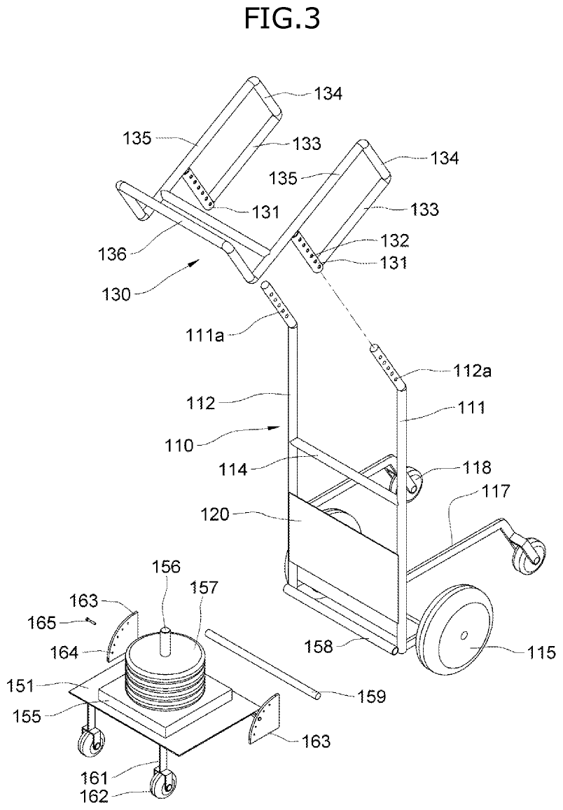

FIG. 1 is an exploded 3D view showing a rehabilitation exercise apparatus for the spine and knees according to a first preferred embodiment of the present invention, FIG. 2 is an exploded 3D view showing the rehabilitation exercise apparatus for the spine and knee according to the first preferred embodiment of the present invention, and FIG. 3 is an exploded 3D view showing the rehabilitation exercise apparatus for the spine and knees according to the first preferred embodiment of the present invention.

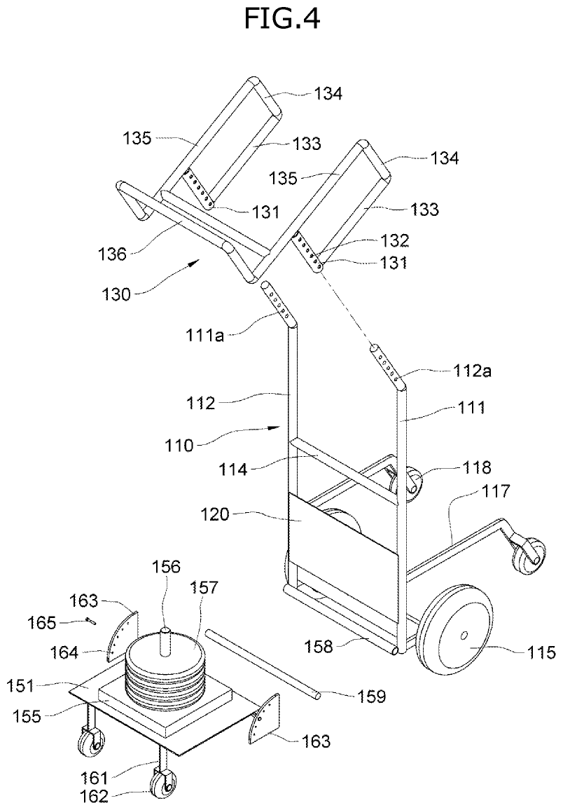

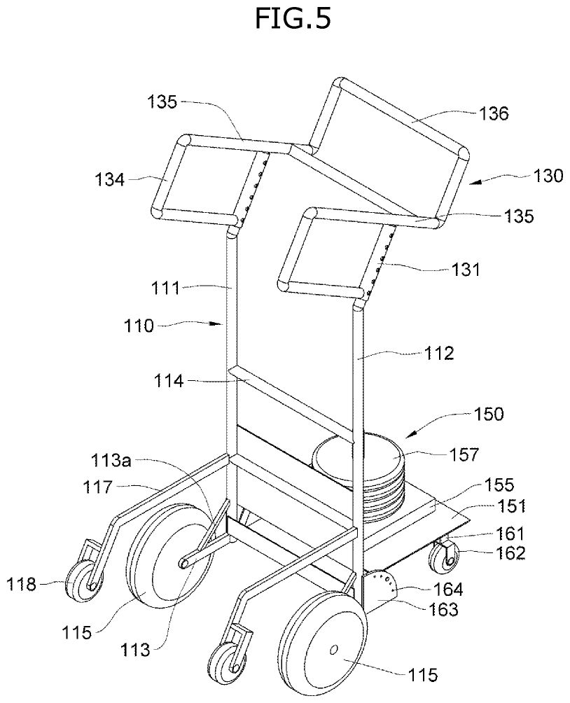

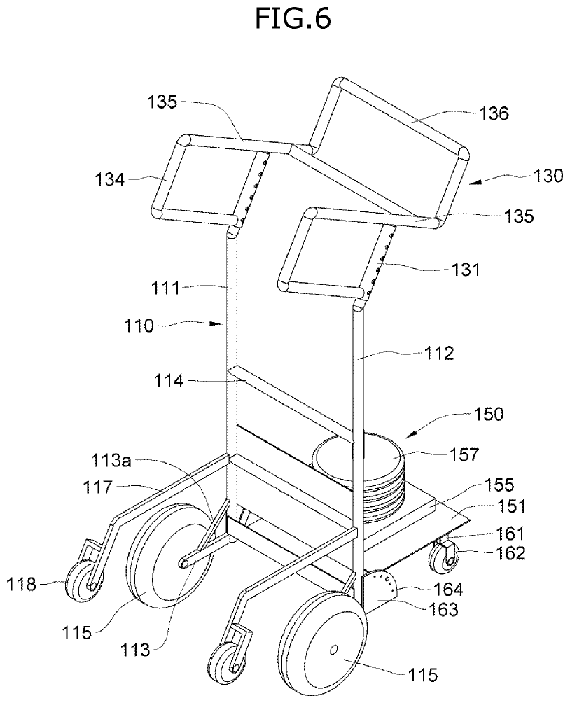

FIG. 4 is a 3D diagram showing the rehabilitation exercise apparatus for the spine and knees according to the first preferred embodiment of the present invention, FIG. 5 is a 3D diagram showing the rehabilitation exercise apparatus for the spine and knees according to the first preferred embodiment of the present invention, and FIG. 6 is a front view showing the rehabilitation exercise apparatus for the spine and knees according to the first preferred embodiment of the present invention.

As shown in FIGS. 1 to 6, the rehabilitation exercise apparatus for the spine and knees according to an embodiment of the present invention includes a body member 110, a load support member 130 detachably coupled to the body member 110, and a weight member 150 configured to apply weight to the load support member 130.

The body member 110 includes: a first vertical frame 111 formed vertically, and provided with a plurality of height adjustment holes 111a at regular height intervals to enable the coupling of the load support member 130 to the upper portion; vertical a second frame 112 formed vertically, and provided with a plurality of height adjustment holes 112a at regular height intervals to enable the coupling of the load support member 130 to the upper portion; lower horizontal frames 113 fixed to the fronts of the vertical frames 111 and 112; moving wheels 115 rotatably coupled to the lower horizontal frames 113; and auxiliary wheel units 116 installed to move along the ground together with the moving wheels 115 by pulling the body member 110 by a predetermined angle.

The first vertical frame 111 and the second vertical frame 112 are formed at a predetermined height, and the height adjustment holes 111a and 112a are formed in the upper portions of the vertical frames 111 and 112 at regular intervals to adjust the height of the load support member 130.

The lower horizontal frames 113 each protruding to one side are fixed to the lower portions of the vertical frames 111 and 112 so that the moving wheels 115 can be installed thereon, and bracings 113a are fixed such that the lower horizontal frames 113 are firmly fixed.

In addition, upper horizontal frames 114 are fixed to the vertical frames 111 and 112 at regular height intervals, and the moving wheels 115 are rotatably coupled to the lower horizontal frame 113.

Furthermore, the auxiliary wheel units 116 are installed on the vertical frames 111 and 112. When the body member 110 is pulled toward a user, the auxiliary wheel units 116 are brought into contact with the ground together with the moving wheels 115, allow the vertical frames 111 and 112 to be rotated by a limited angle, and move along the ground together with the moving wheels 115.

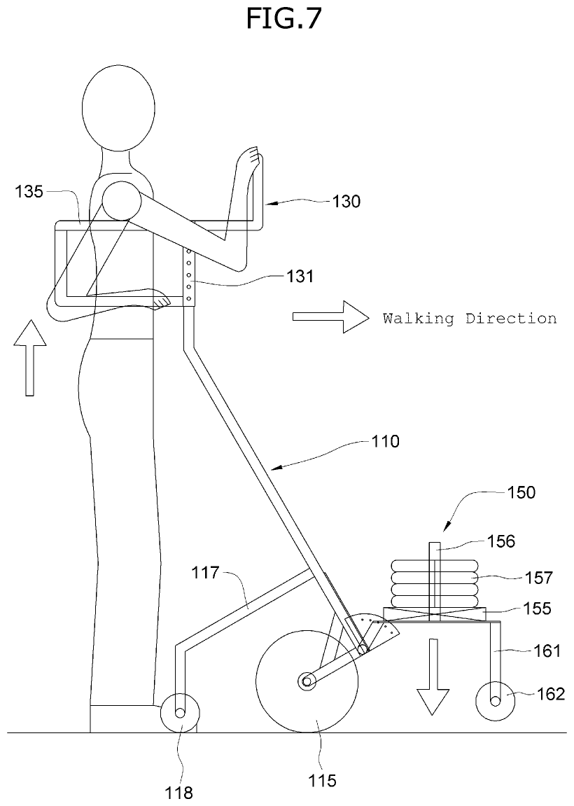

That is, as the vertical frames 111 and 112 are tilted toward the user, the auxiliary wheel units 116 come into contact with the ground, as shown in FIG. 7.

The auxiliary wheel units 116 are configured such that auxiliary frames 117 are fixed to the vertical frames 111 and 112 and auxiliary wheels 118 are installed on the auxiliary frames 117 so that they can rotate along the ground.

Meanwhile, a front plate 119 is installed on first sides of the vertical frames 111 and 112, and a rear plate 120 is installed on second sides of the vertical frames 111 and 112.

The load support member 130 includes: a pair of height adjustment frames 131 coupled to the vertical frames 111 and 112, and provided with a plurality of height adjustment holes 132 that are formed at regular intervals corresponding to the height adjustment holes 111a and 112a of the vertical frames 111 and 112; a pair of lower support 133 extending to first sides of the height adjustment frames 131, and fixed in the horizontal direction to the height adjustment frames 131 to support a user's arms; vertical frames 134 fixed in the vertical direction to first ends of the lower support frames 133; a pair of shoulder support frames 135 fixed to the top ends of the vertical frames 134 to support the user's shoulders so that they are located above the lower support frames 133; and a front grip frame 136 formed between the pair of shoulder support frames 135 in an integrated form so that the user can pull the body member 110 and the weight member 150.

The load supporting member 130 may lift the user's body as the user rotates the body member 110 by a predetermined angle, thereby reducing the load applied by the user's body weight to the spine (or the waist) and knees.

The height adjustment frames 131 of the load support member 130 are detached from the vertical frames 111 and 112, and the height adjustment holes 132 corresponding to the height adjustment holes 111a and 112a are formed in the height adjustment frames 131 at regular intervals.

The lower support frames 133 are installed to first sides at the bottom ends of the height adjustment frames 131, and the lower support frames 133 support the user's arms.

That is, as shown in FIG. 7, the user can stably support the upper body by placing the arms on the lower support frames 133 while holding the lower support frames 133.

Furthermore, the vertical frames 134 having a predetermined height are installed at the front ends of the lower support frames 133, and the shoulder support frames 135 are installed at the top ends of the vertical frames 134.

The shoulder support frames 135 support the user's shoulders, so that the user's weight is carried on the shoulder support frames 135. That is, the user may maintain a standing position on the shoulder support frames 135.

Accordingly, the user's body weight can be comfortably and stably maintained in an upright position in which the user walks in the state in which the weight is not applied to the spine and knees due to the load support member 130.

Furthermore, the front grip frame 136 is installed on the fronts of the shoulder support frames 135 to enable the user to grip the load support member 130.

The weight member 150 includes: a base body 151 formed in a predetermined size; angle adjustment frames 152 formed to be inclined at a predetermined angle on one side of the base body 151 so that the base body 151 can be rotated; angle adjustment holes 154 formed in the angle adjustment frames 152; a buffer plate 155 installed on the top surface of the base body 151; a plurality of weights 157 installed on the top surface of the buffer plate 155 so that a predetermined amount of weight can be applied to the load support member 130; a rotation frame 158 fixed to the vertical frames 111 and 112 of the body member 110; a rotation axis 159 coupled to the rotation frame 158 so that the angle of the angle adjustment frame 152 can be adjusted; and auxiliary wheel units 160 installed on the bottom surface of the base body 151.

The base body 151 of the weight member 150 is formed in a predetermined size, and the angle adjustment frames 152 are formed on first sides of the base body 151 in integrated forms.

Coupling holes 153 are formed at the front ends of the angle adjustment frames 152 so that a rotation shaft 159 can be coupled thereto, and angle adjustment holes 154 are formed in the angle adjustment frames 152 so that angle adjustment is enabled.

The buffer plate 155 is installed on the top surface of the base body 151 to reduce the impact applied from the weights 157, and a vertical rod 156 is fixed at the center of the base body 151 to prevent the weights 157 from moving.

The vertical rod 156 is provided with a plurality of weights 157 to adjust the weight according to the user's body weight.

A rotation frame 158 is installed on the vertical frames 111 and 112 of the body member 110 to rotate the weight member 150, and the rotation axis 159 is coupled to the rotation frame 158 and the angle adjustment hole 154.

In other words, the base body 151 is rotatably coupled to the rotation frame 158 and the rotation axis 159 coupled to the angle adjustment hole 154.

In addition, the auxiliary wheel units 160 are installed on the bottom surface of the base body 151, the pair of wheel frames 161 are installed on the bottom surface of the base body 151, and auxiliary wheels 162 are rotatably coupled to the wheel frames 161.

Furthermore, the angle adjustment plates 163 are installed on the vertical frames 111 and 112, a plurality of angle adjustment holes 164 are formed at regular intervals in each of the angle adjustment plate 163, and fixing pins 165 are provided to be inserted into the angle adjustment holes 154 of the base body 151.

Next, a method of operating a rehabilitation exercise apparatus for the spine and knees according to a preferred embodiment of the present invention will be described with reference to FIGS. 1 to 7.

FIG. 7 is a front view showing a state in which the rehabilitation exercise apparatus for the spine and knees according to the first preferred embodiment of the present invention is tilted.

As shown in FIG. 7, the user (a patient, or a rehabilitation exercise subject) inserts the plurality of weights 157 into the vertical rod 156 of the weight member 150 and places them so that walking or rehabilitation exercise can be performed.

In this case, the user adjusts his or her weight or the weight required for rehabilitation exercise by varying the number of weights 157.

In addition, in addition to adjusting the weight of the weights 157, the user adjusts the fixing pins 165 to the angle adjustment holes 164 of the angle adjustment plates 163 and the angle adjustment holes 154 of the angle adjustment frames 152 at appropriate positions.

In other words, the user may lift the weights 157 installed on the weight body 151 by inserting and engaging the fixing pins 165 in appropriate positions according to the intensity (or the pressure) desired for exercise.

When the fixing pins 165 are installed into the lower sides of the angle adjustment plates 164, the user lifts the relatively light weights 157. When the fixing pins 165 are installed into the upper sides of the angle adjustment plates 164, the user lifts the relatively heavy weights 157.

After the appropriate number of weights 157 and the angle are adjusted according to the intensity or amount of exercise desired for exercise, the user pulls the load support member 130 toward the front of the body while holding it.

Accordingly, the vertical frames 111 and 112 of the body member 110 are rotated by a predetermined angle as shown in FIG. 7, and the user rests his or her shoulder on the shoulder support frame 135 so that rehabilitation exercise or walking can be performed.

As the user rests his or her shoulder on the shoulder support frame 135, the user's feet remain lifted from the ground to a predetermined height.

In other words, the weights 157 lift the user's body from the ground while the user is upright, thereby reducing the load applied by the user's body weight to the spine (or waist) and knees.

In this way, unlike in the case where the user walks upright, the user can comfortably and stably perform rehabilitation exercise with less weight applied to the spine and knees.

### Second Embodiment

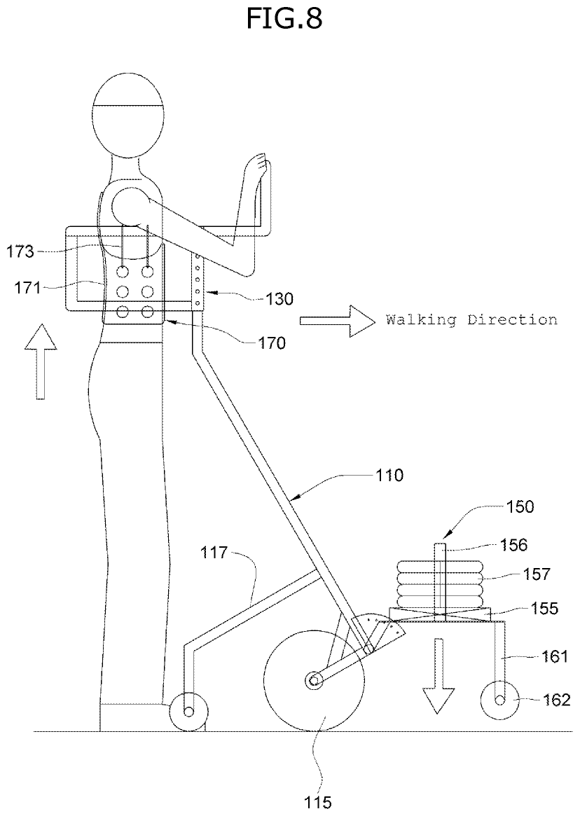

FIG. 8 is a front view showing a state in which a rehabilitation exercise apparatus for the spine and knees according to a preferred second embodiment of the present invention is tilted.

As shown in FIG. 8, the rehabilitation exercise apparatus according to the second embodiment of the present invention includes a waist protector member 170 configured to be worn on a user's waist.

Since a body member 110, a load support member 130, and a weight member 150 according to the second embodiment of the present invention are the same as those of the first embodiment described above, redundant descriptions thereof will be omitted, and the same names will be described using the same reference numerals.

As shown in FIG. 8, the waist protector member 170 includes: a waist protector 171 configured to surround a user's waist; a shoulder passage portion 172 formed to allow the user's shoulder to be inserted thereinto; and fixing rings 173 configured to fix the waist protector 171 to the shoulder support frames 135

The waist protector 171 is formed in a shape that can cover the user's waist and back, and is of course provided with a belt or buckle (not shown) so that it can be worn on the user's waist.

In the rehabilitation exercise apparatus according to the second embodiment, the weight member 150 is lifted by rotating the body member 110 while the waist protector 171 is worn on the waist.

Accordingly, the user may hold the lower support frame 133, and may support the shoulder on the shoulder support frames 135 and, at the same time, stably lift the upper body by the waist protector 171.

This allows a user with spinal (or lower back) instability to safely protect the spine and perform rehabilitation exercise while walking by wearing the waist protector 171 that surrounds the overall spine.

### Third Embodiment

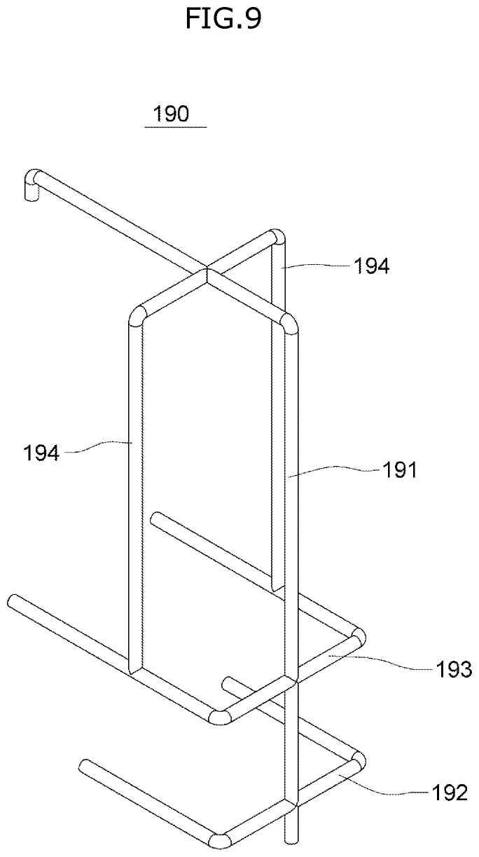

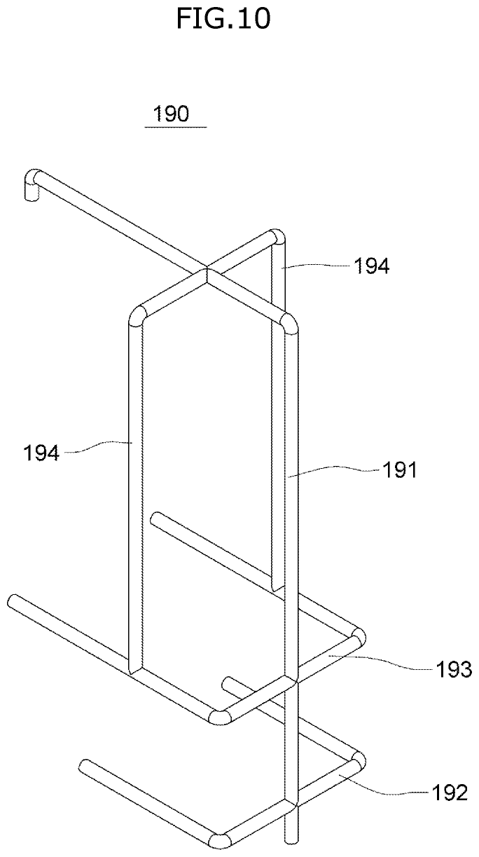

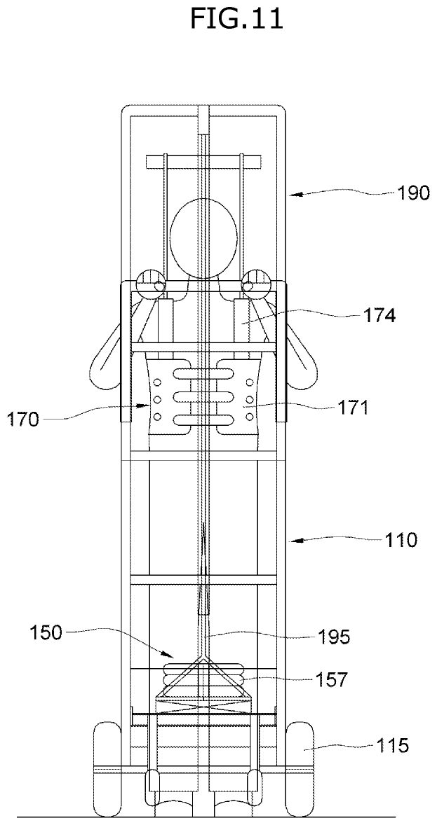

FIG. 9 is a 3D view showing the wire traction member of a rehabilitation exercise apparatus for the spine and knee according to a third preferred embodiment of the present invention, FIG. 10 is a front view showing a state in which the rehabilitation exercise apparatus for the spine and knees according to the third preferred embodiment of the present invention, the wire traction member, and a waist protector are worn, and FIG. 11 is a side view showing a state in which the rehabilitation exercise apparatus for the spine and knees according to the third preferred embodiment of the present invention, the wire traction member, and the waist protector are worn.

As shown in FIGS. 9 to 11, the rehabilitation exercise apparatus for the spine and knees according to the third embodiment of the present invention further includes a wire traction member 190 installed on a body member 110 to lift a weight member 150 more safely.

The wire traction member 190 includes: a central vertical frame 191 formed in an inverted and reversed ‘L’ shape; a lower horizontal frame 192 fixed to the lower portion of the central vertical frame 191 so that the central vertical frame 191 can be fixed to the body member 110; an upper fixing frame 193 fixed to the upper side of the lower horizontal frame 192 so that the central vertical frame 191 can be fixed to the body member 110; a pair of vertical frames 194 fixed to the upper portion of the central vertical frame 191 and the upper fixing frame 193; and a wire 195 movably installed inside the central vertical frame 191.

The body member 110, a load support member 130, and the weight member 150 according to the third embodiment of the present invention may be used slightly differently from the first embodiment described above.

Shoulder support frames 135 and a base body 151 are adjusted to be parallel with angle adjustment plates 163 and angle adjustment pins 165, so that moving wheels 115 and auxiliary wheels 162 come into close contact with the ground and auxiliary wheels 118 are in a floating state.

A user wears a waist protection member 170 and connects wire connection rings 174 to a shoulder strap, and a rehabilitation instructor places weights 157 on a buffer plate 155 and appropriately ties the weights 157 with the wire 195 in a pyramid shape to transfer the load of the weights 157 to the waist protector member 170 so that a user's body is lifted from the ground to a predetermined height and, thus, the user can walk with the load on the spine and knees reduced and perform rehabilitation exercise together with the rehabilitation instructor.

The central vertical frame 191 of the wire traction member 190 has an overall shape of approximately an inverted and reversed ‘L’ shape, and a lower horizontal frame 192 having an overall shape of a sideways ‘U’ shape when viewed from a plan view is installed on the lower portion of the central vertical frame 191.

In addition, an upper horizontal frame 193 having an overall shape of a sideways ‘U’ shape is installed at a predetermined height of the central vertical frame 191, and first ends of the horizontal frames 192 and 193 are detachably coupled to the vertical frames 111 and 112 of the body member 110.

The vertical frames 194 having an overall shape of an approximately inverted ‘U’ shape are installed on the upper horizontal frame 193, and the wire 195 connected between the weight member 150 and the waist protector 170 is installed inside the central vertical frame 191.

The lower end of the wire 195 is bound to the weights 157, and the upper end of the wire 195 is connected to the wire connection rings 174 on the shoulder straps of the waist protector member 170.

As described above, while wearing the waist protector 170, the user can perform rehabilitation exercise or walk in a state in which the body is lifted to a predetermined height from the ground by the load of the weights 157.

Although the present invention conceived by the present inventor has been described in detail according to the above-described embodiments, it is obvious that the present invention is not limited to the above-described embodiments and can be changed in various manners without departing from the gist of the present invention.

1. A rehabilitation exercise apparatus for a spine and knees, the rehabilitation exercise apparatus comprising:
a body member (110) configured such that moving wheels (115) are installed at bottoms of a pair of vertical frames (111, and 112) spaced apart from each other by a predetermined distance;
a load-support member (130) coupled to the pair of vertical frames (111 and 112) in a height-adjustable manner, and coupled to the vertical frames (111 and 112) to support a user's upper body; and
a weight member (150) installed on one side of the lower portion of the body member (110) so that weights corresponding to a weight of the user's upper body can be transmitted to the load support member (130) as the load support member (130) is rotated by a predetermined angle.

2. The rehabilitation exercise apparatus of claim 1, further comprising:
a waist protector member (170) worn on the user's waist and shoulders; and
a wire traction member (190) installed on the body member (110) to lift the weight member (150) more safely.

3. The rehabilitation exercise apparatus of claim 1, wherein the body member (110) includes:
the first vertical frame (111) formed vertically, and configured such that a plurality of height adjustment holes (111a) are formed at regular height intervals to enable coupling of the load support member (130) to an upper portion thereof;
the second vertical frame (112) formed vertically, and configured such that a plurality of height adjustment holes (112a) are formed at regular height intervals to enable coupling of the load support member (130) to an upper portion thereof;
lower horizontal frames (113) fixed to front surfaces of the vertical frames (111 and 112);
moving wheels (115) rotatably coupled to the lower horizontal frames (113); and
auxiliary wheel units (116) installed to be movable along a ground together with the moving wheels (115) as the body member (110) is pulled by a predetermined angle.

4. The rehabilitation exercise apparatus of claim 1, wherein the load support member (130) includes:
a pair of height adjustment frames (131) coupled to the vertical frames (111 and 112), and provided with a plurality of height adjustment holes (132) that are formed at regular intervals corresponding to the height adjustment holes (111a and 112a) of the vertical frames (111 and 112);
a pair of lower support frames (133) extending to first sides of the height adjustment frames (131), and fixed in a horizontal direction to the height adjustment frames (131) to support the user's arms;
vertical frames (134) fixed in the vertical direction to first ends of the lower support frames (133);
a pair of shoulder support frames (135) fixed to top ends of the vertical frames (134) to support the user's shoulders so that they are located above the lower support frames (133); and
a front grip frame (136) formed between the pair of shoulder support frames (135) in an integrated form so that the user can pull the body member (110) and the weight member (150).

5. The rehabilitation exercise apparatus of claim 1, wherein the weight member (150) includes:
a base body (151) formed in a predetermined size;
angle adjustment frames (152) formed to be inclined at a predetermined angle on one side of the base body (151) so that the base body (151) can be rotated;
angle adjustment holes (154) formed in the angle adjustment frames (152);
a buffer plate (155) installed on a top surface of the base body (151);
a plurality of weights (157) installed on a top surface of the buffer plate (155) so that a predetermined amount of weight can be applied to the load support member (130);
a rotation frame (158) fixed to the vertical frames (111 and 112) of the body member (110);
a rotation axis (159) coupled to the rotation frame (158) so that the angle of the angle adjustment frame (152) can be adjusted; and
auxiliary wheel units (160) installed on a bottom surface of the base body (151).

6. The rehabilitation exercise apparatus of claim 2, wherein the wire traction member (190) includes:
a central vertical frame (191) formed in an inverted and reversed ‘L’ shape;
a lower horizontal frame (192) fixed to a lower portion of the central vertical frame (191) so that the central vertical frame (191) can be fixed to the body member (110);
an upper fixing frame (193) fixed to an upper side of the lower horizontal frame (192) so that the central vertical frame (191) can be fixed to the body member (110);
a pair of vertical frames (194) fixed to an upper portion of the central vertical frame (191) and the upper fixing frame (193); and
a wire (195) movably installed inside the central vertical frame (191).

7. The rehabilitation exercise apparatus of claim 2, wherein the body member (110) includes:
the first vertical frame (111) formed vertically, and configured such that a plurality of height adjustment holes (111a) are formed at regular height intervals to enable coupling of the load support member (130) to an upper portion thereof;
the second vertical frame (112) formed vertically, and configured such that a plurality of height adjustment holes (112a) are formed at regular height intervals to enable coupling of the load support member (130) to an upper portion thereof;
lower horizontal frames (113) fixed to front surfaces of the vertical frames (111 and 112);
moving wheels (115) rotatably coupled to the lower horizontal frames (113); and
auxiliary wheel units (116) installed to be movable along a ground together with the moving wheels (115) as the body member (110) is pulled by a predetermined angle.

8. The rehabilitation exercise apparatus of claim 2, wherein the load support member (130) includes:
a pair of height adjustment frames (131) coupled to the vertical frames (111 and 112), and provided with a plurality of height adjustment holes (132) that are formed at regular intervals corresponding to the height adjustment holes (111a and 112a) of the vertical frames (111 and 112);
a pair of lower support frames (133) extending to first sides of the height adjustment frames (131), and fixed in a horizontal direction to the height adjustment frames (131) to support the user's arms;
vertical frames (134) fixed in the vertical direction to first ends of the lower support frames (133);
a pair of shoulder support frames (135) fixed to top ends of the vertical frames (134) to support the user's shoulders so that they are located above the lower support frames (133); and
a front grip frame (136) formed between the pair of shoulder support frames (135) in an integrated form so that the user can pull the body member (110) and the weight member (150).

9. The rehabilitation exercise apparatus of claim 2, wherein the weight member (150) includes:
a base body (151) formed in a predetermined size;
angle adjustment frames (152) formed to be inclined at a predetermined angle on one side of the base body (151) so that the base body (151) can be rotated;
angle adjustment holes (154) formed in the angle adjustment frames (152);
a buffer plate (155) installed on a top surface of the base body (151);
a plurality of weights (157) installed on a top surface of the buffer plate (155) so that a predetermined amount of weight can be applied to the load support member (130);
a rotation frame (158) fixed to the vertical frames (111 and 112) of the body member (110);
a rotation axis (159) coupled to the rotation frame (158) so that the angle of the angle adjustment frame (152) can be adjusted; and
auxiliary wheel units (160) installed on a bottom surface of the base body (151).
